(19) United States
(12) Patent Application Publication
(10) Pub. No.: US 2005/0048177 A1
(43) Pub. Date: Mar. 3, 2005

(54) Frozen food item and mold system and method therefor

(76) Inventor: Daniel J. Reardon, Scottsdale, AZ (US)

Correspondence Address: WEISS & MOY PC, 4204 NORTH BROWN AVENUE, SCOTTSDALE, AZ, 85251, US

(21) Appl. No.: 10/917,612

(22) Filed: Aug. 13, 2004

Related U.S. Application Data
(60) Provisional application No. 60/497,231, filed on Aug. 22, 2003.

(51) Int. Cl. A23G 1/00

(52) U.S. Cl. 426/383

(57) ABSTRACT

A novelty food item has an edible portion. The edible portion is in a shape of an oversized head of a creature. A handle is provided for holding the edible portion. The handle is in a shape of the creature having a body section and a head section. The head section is smaller than the oversize head of the edible portion. The handle is positioned in the edible portion so that the head section of the handle is positioned inside the edible portion and the body section is exposed.

### RELATED APPLICATIONS

This patent application is claiming the benefit of U.S. Provisional Application entitled “FROZEN FOOD MOLD SYSTEM AND METHOD THEREFOR”, filed on Aug. 22, 2003, having a Ser. No. 60/497,231, and in the name of Daniel J. Reardon.

### BACKGROUND OF THE INVENTION

1. Field of the Invention

This invention relates to a novelty food item and, more specifically, to unique shaped frozen food items and a mold device for creating the unique shaped frozen food items.

2. Description of the Prior Art

It is generally a well known fact that the success of many products depend a lot on the look and appearance of that item. Indeed, the commercial success of many marketable products often depends largely on the attractiveness of the product, or the interest it holds for the consumer. Novelty items often provide a unique, attractive, or amusing appearance to attract the consumer. Novelty items of all kinds are sold in may different types of stores as well as fairs, carnivals, amusement parks, and other similar environments. The term “novelty item” broadly encompasses toys, food items, and other devices that provide some sort of amusement or entertainment for the consumer.

As used herein, novelty items refer to inanimate articles of manufacture that are intended to provide, even for only a few moments, amusement, entertainment, decoration or recreation. The use for recreation or entertainment may be the only use for the items or may be in addition to other uses or benefits of the items.

With regard to consumable food items, manufacturers have been trying to find unique ways to provide low cost ways to entertain consumers with their items. It is known that users often desire much more than just the food item, but also desire an amusement or entertainment component. For example, lollipops or suckers have been formed in the shape of whistles to allow a person to make a whistle sound with the item, as well as eat it.

Many such items have been the subject of U.S. patents. For example, U.S. Pat. No. 5,946,773 is directed to a food product having a uniquely shaped and multi-colored handle. U.S. Pat. No. U.S. Pat. No. 5,666,693 discloses a unique toy handle for an oral device, such as a lollipop or popsicle. Specifically, FIGS. 1A-1C of that patent illustrate a handle in the shape of the back end of an animal, like a lizard or a frog. This uniquely-shaped handle gives the appearance of the consumer eating a frog or lizard, when the consumable end of the product is held in the mouth of the consumer. However, the toy handles are three dimensional handles which are expensive to manufacture. U.S. Design Pat. Des. 420,199 shows a unique shape frozen confection item. However, the size and shape of the item makes it extremely difficult to eat.

Therefore, a need existed to provide an improved frozen food novelty item that overcomes the above problems.

### SUMMARY OF THE INVENTION

In accordance with one embodiment of the present invention, it is an object of the present invention to provide an improved frozen food novelty item.

It is another object of the present invention to provide an improved frozen food novelty item that overcomes the problems associated with prior art frozen food novelty item.

The foregoing and other objects, features, and advantages of the invention will be apparent from the following, more particular, description of the preferred embodiments of the invention, as illustrated in the accompanying drawing.

### BRIEF DESCRIPTION OF THE EMBODIMENTS

In accordance with one embodiment of the present invention a novelty food item is disclosed, The novelty food item has an edible portion. The edible portion is in a shape of an oversized head of a creature. A handle is provided for holding the edible portion. The handle is in a shape of the creature having a body section and a head section. The head section is smaller than the oversize head of the edible portion. The handle is positioned in the edible portion so that the head section of the handle is positioned inside the edible portion and the body section is exposed.

The foregoing and other objects, features, and advantages of the invention will be apparent from the following, more particular, description of the preferred embodiments of the invention, as illustrated in the accompanying drawing.

### BRIEF DESCRIPTION OF THE DRAWINGS

The invention itself, as well as a preferred mode of use, and advantages thereof, will best be understood by reference to the following detailed description of illustrated embodiment when read in conjunction with the accompanying drawings, wherein like reference numerals and symbols represent like elements.

FIG. 1 is an elevated perspective view of one embodiment of a frozen food item made from the frozen food mold system of the present invention.

FIG. 2 is a front view of one embodiment of the stick portion of the frozen food mold system of the present invention.

FIG. 3 is a front view of the mold portion of one embodiment of the frozen food mold system of the present invention.

FIG. 4 is a side view of the frozen food mold system of the present invention.

FIG. 5 is an elevated perspective view of another embodiment of a frozen food item made from the frozen food mold system of the present invention.

FIG. 6 is a front view of the stick portion of FIG. 5 used in the frozen food mold system of the present invention.

FIG. 7 is a cross section view of the mold portion depicted in FIG. 3.

### DETAILED DESCRIPTION OF THE PREFERRED EMBODIMENT

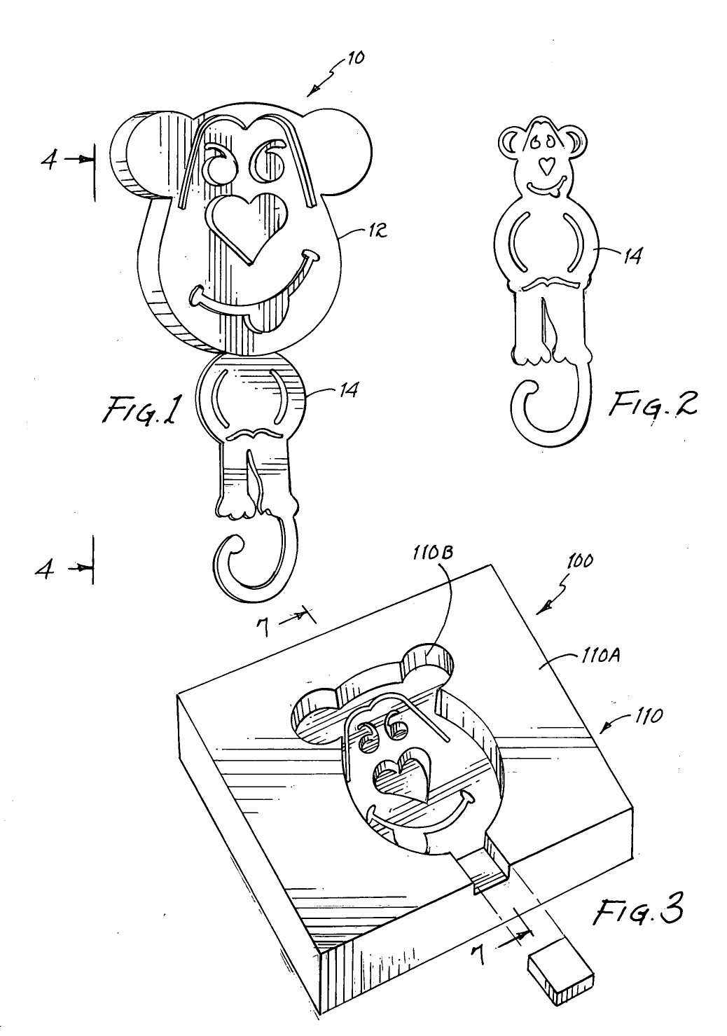

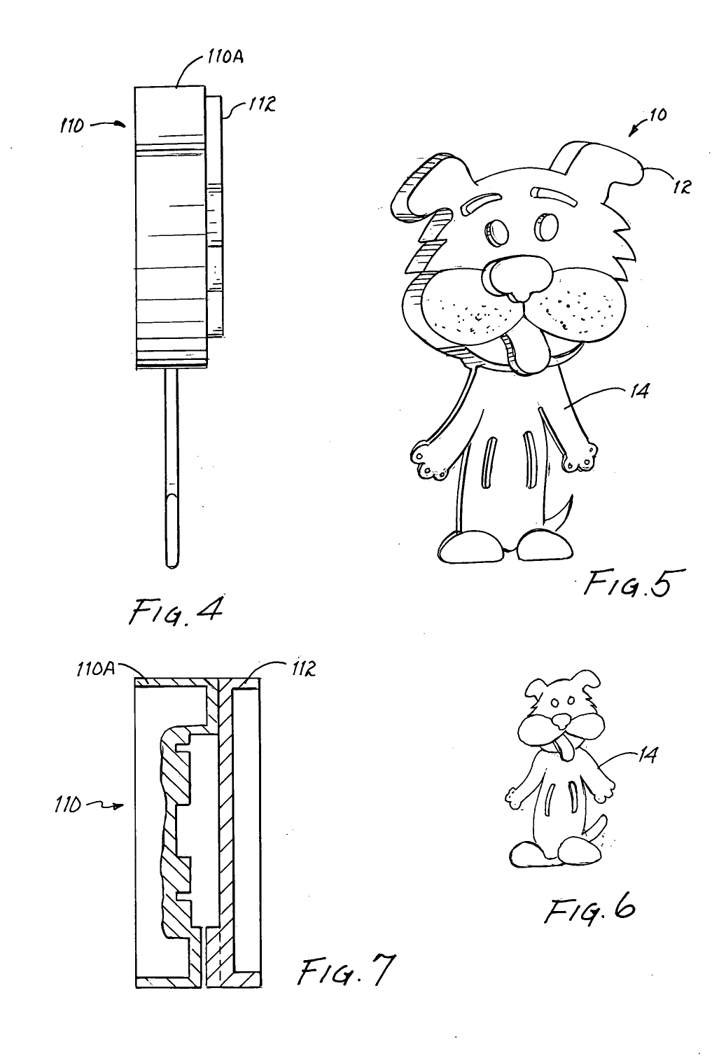

Referring to the Figures, a novel frozen food item 10 and mold system 100 for making the frozen food item 10 will be disclosed. The frozen food item 10 has a head section 12 and a stick section 14. The head section 12 is generally in the shape of a head of an animal. For example, FIG. 1 shows the head section 12 in the shape of a monkey head while FIG. 5 shows the head section 12 in the shape of a dog head. It should be noted that the head section 12 may be in the shape of other items such as human caricature head, cartoon character head, and the like. The head section 12 may have facial characteristics such as eyes, a nose, a mouth, and the like. The listing of the above should not be seen as to limit the scope of the present invention. The facial characteristics of the head section 12 may be raised three dimensional characteristics or two dimensional features which are added to the appearance of the head section 12. The two dimensional features may be added by coloring the features in different colors.

The head section 12 is an edible section. The head section 12 can be a candy, frozen snack item such as ice cream or yogurt, frozen fruit bar, or the like. The listing of the above should not be seen as to limit the scope of the present invention. If facial features are part of the head section 12, the facial features are edible as well.

The stick section 14 is used to hold the frozen food item 10. The stick section 14 is generally shaped like a miniaturized animal having a full body and head. For example, FIG. 2 shows the stick section 14 in the shape of a monkey while FIG. 6 shows the stick section 14 in the shape of a dog. However, like the head section 12, the stick section 14 may take the shape of other items such as human caricature body, cartoon character body, and the like. The stick section 14 is generally made to be of a smaller size than the head section 12. This will give the appearance of a large headed animal having a small body. The stick section 14 is made out of a nonedible material. Plastic, wood, or the like may be used. The listing of the above materials should not be seen as to limit the scope of the present application. The stick section 14 may further come in a variety of different colors.

The frozen food item 10 will thus have an enlarged frozen edible head section 12. The stick section 14 will be positioned within the head section 12 so that only the body section of the stick section 14 is showing. Thus, the frozen food item 10 will look like an animal having an enlarge head and a small body. Once the edible head section 12 is eaten, the stick section 14 (in the shape of the animal) is left as a souvenir.

The frozen food item 10 is formed by pouring a liquid version of the edible item into a mold section 110. The liquid version of the edible item may be fruit juice, liquid ice cream, liquified candy, and the like. The listing of the above should not be seen as to limit the scope of the present invention.

The mold section 110 will generally be a block member 110A having a void area 110B. The void area 110B will be in the shape of an animal head. The void area 110B may be formed so as to have different levels thereby forming the facial features on the animal head.

After the liquid version of the edible item is poured into the void area 110B of the mold section 110, the stick section 14 is positioned inside the mold so that only the body section of the stick section 14 is showing. A lid 112 is then coupled to the mold section 110 holding the stick section in place and preventing the liquid version of the edible item from leaking out. The liquid version of the edible item is then allowed to harden. It is allowed to harden by placing the entire mold system 100 in a freezer or the like. Once the liquid is allowed to harden, the lid 112 is removed and the frozen food item 10 is removed.

The frozen food item may then be coated/dipped in chocolate or other like items. One may then eat the edible head section 12 while holding the stick section 14. Once the edible head section 12 is eaten, the stick section 14 (in the shape of the animal, human caricature, cartoon character, and the like) is left as a souvenir.

While the invention has been particularly shown and described with reference to preferred embodiments thereof, it will be understood by those skilled in the art that the foregoing and other changes in form and details may be made therein without departing from the spirit and scope of the invention.

1. A novelty food item comprising:
an edible portion wherein the edible portion is in a shape of an oversized head of a creature; and
a handle for holding the edible portion, the handle having a shape of the creature having a body section and a head section, wherein the head section is smaller than the oversize head of the edible portion, the handle being positioned in the edible portion so the head section of the handle is positioned inside the edible portion and the body section is exposed.

2. A novelty food item in accordance with claim 1 wherein the oversized head of the edible portion has facial characteristics.

3. A novelty food item in accordance with claim 2 wherein the facial characteristics are raised three dimensional facial characteristics.

4. A novelty food item in accordance with claim 2 wherein the facial characteristics are colored in two dimensional features.

5. A novelty food item in accordance with claim 1 wherein the oversized head of the edible portion is one of candy, frozen ice cream, frozen yogurt, frozen fruit bar, and combinations thereof.

6. A novelty food item in accordance with claim 1 wherein the creature is an animal.

7. A novelty food item in accordance with claim 1 wherein the creature is a caricature of a real human.

8. A novelty food item in accordance with claim 1 wherein the creature is a cartoon character.
